(19) United States
(12) Patent Application Publication
(10) Pub. No.: US 2025/0190229 A1
(43) Pub. Date: Jun. 12, 2025

(54) METHODS AND SYSTEMS FOR REMOTELY MONITORING SUB-SYSTEMS

(71) Applicant: MVC Mobile Videocommunication GmbH, Kronberg im Taunus (DE)

(72) Inventor: Dave Carr, Kronberg im Taunus (DE)

(73) Assignee: MVC Mobile Videocommunication GmbH, Kronberg im Taunus (DE)

(21) Appl. No.: 18/845,124

(22) PCT Filed: Feb. 28, 2023
(86) PCT No.: PCT/FI2023/050115

§ 371 Date: Sep. 9, 2024

(30) Foreign Application Priority Data
Mar. 25, 2022 (FI) 20225262

(51) Int. Cl. G06F 9/445; G06F 9/451; G06F 9/54

(52) U.S. Cl. CPC G06F 9/44526; G06F 9/452; G06F 9/544

(57) ABSTRACT

A method for remotely monitoring sub-systems. The method is implemented by first software application executing on client device(s) communicably coupled to sub-systems. The method includes polling data from sub-systems, wherein a sub-system has at least one of: computing device, server, operating system, second software application, and wherein data from the sub-system is polled at a polling frequency; classifying data into a category from amongst categories; analyzing classified data, based on pre-stored data at centralized server, to determine data points of classified data that have changed; and transmitting data points to centralized server at a upload frequency, for storage thereat.

### TECHNICAL FIELD

The present disclosure relates to methods for remotely monitoring sub-systems. The present disclosure also relates to systems for remotely monitoring sub-systems. The present disclosure also relates to computer program products for remotely monitoring sub-systems.

### BACKGROUND

At a time when a physical access to locations and equipment is restricted, implementations of maintaining systems can be challenging. Knowing exactly what is working and what is having an issue becomes a critical component in keeping every estate running. Thus, remote monitoring of systems is becoming an important aspect for several estates, as such monitoring provides insights for estates' operations that minimises wastes and maximises benefits. Moreover, such monitoring allows users to focus on and leverage their teams in the estate, so as to reduce costs, minimize downtime, and increase agility, within the estate. Thus, development of technologies for remotely monitoring systems is becoming crucial for running an estate undisputedly and for a steady communication flow functioning within the estate.

However, existing technologies for remotely monitoring systems are associated with several limitations. The existing technologies are not well-suited to provide an immediate insight to operations of the systems and to accordingly react when there are issues with the systems. Resultantly, there is no real-time visibility of performances and statuses of the systems and thus, there is a considerable downtime due to a delay between identification of an issue with a system and implementation of actions for rectifying such an issue. Therefore, such existing technologies lack rapid corrective actions to be taken for resolving said issue (by not providing a requisite resource for resolving said issue).

Therefore, in light of the foregoing discussion, there exists a need to overcome the aforementioned drawbacks associated with existing technologies for remotely monitoring systems.

### SUMMARY

The present disclosure seeks to provide a method for remotely monitoring a plurality of sub-systems. The present disclosure also seeks to provide a system for remotely monitoring a plurality of sub-systems. The present disclosure also seeks to provide a computer program product for remotely monitoring a plurality of sub-systems. An aim of the present disclosure is to provide a solution that overcomes at least partially the problems encountered in prior art.

In a first aspect, an embodiment of the present disclosure provides a method for remotely monitoring a plurality of sub-systems, the method being implemented by a first software application executing on at least one client device that is communicably coupled to the plurality of sub-systems, the method comprising:
polling the data from the plurality of sub-systems, wherein a given sub-system comprises at least one of: a computing device, a server, an operating system, a second software application, and wherein data from the given sub-system is polled at a given polling frequency;
classifying the data into a given category from amongst a plurality of categories;
analyzing the classified data, based on pre-stored data at a centralized server, to determine a plurality of data points of the classified data that have changed; and
transmitting the plurality of data points to the centralized server at a given upload frequency, for storage thereat.

In a second aspect, an embodiment of the present disclosure provides a system for remotely monitoring a plurality of sub-systems, the system comprising at least one client device communicably coupled to the plurality of sub-systems, wherein the at least one client device is configured to execute a first software application for implementing a method according to the first aspect.

In a third aspect, an embodiment of the present disclosure provides a computer program product for remotely monitoring a plurality of sub-systems, the computer program product comprising a non-transitory machine-readable data storage medium having stored thereon program instructions that, when accessed by a processing device, cause the processing device to implement a method according to the first aspect.

Embodiments of the present disclosure substantially eliminate or at least partially address the aforementioned problems in the prior art, and enable efficient, accurate remote monitoring of sub-systems in real time or near-real time.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 illustrates a flowchart depicting steps of a method for remotely monitoring a plurality of sub-systems, in accordance with an embodiment of the present disclosure;

FIGS. 2A and 2B illustrate block diagrams of architectures of a system for remotely monitoring a plurality of sub-systems, in accordance with an embodiment of the present disclosure;

FIG. 3 illustrates an exemplary scenario of using plugins, in accordance with an embodiment of the present disclosure;

FIG. 4 illustrates various types of categories of classifying data, in accordance with an embodiment of the present disclosure;

FIG. 5 illustrates a process flow executed by a centralized server, in accordance with an embodiment of the present disclosure;

FIG. 6 illustrates an exemplary interactive user interface on a device associated with an estate administrator, in accordance with an embodiment of the present disclosure; and

FIG. 7 illustrates an exemplary use case of a system for remotely monitoring a plurality of sub-systems, in accordance with an embodiment of the present disclosure;

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, an embodiment of the present disclosure provides a method for remotely monitoring a plurality of sub-systems, the method being implemented by a first software application executing on at least one client device that is communicably coupled to the plurality of sub-systems, the method comprising:
polling the data from the plurality of sub-systems, wherein a given sub-system comprises at least one of: a computing device, a server, an operating system, a second software application, and wherein data from the given sub-system is polled at a given polling frequency;
classifying the data into a given category from amongst a plurality of categories;
analyzing the classified data, based on pre-stored data at a centralized server, to determine a plurality of data points of the classified data that have changed; and
transmitting the plurality of data points to the centralized server at a given upload frequency, for storage thereat.

In a second aspect, an embodiment of the present disclosure provides a system for remotely monitoring a plurality of sub-systems, the system comprising at least one client device communicably coupled to the plurality of sub-systems, wherein the at least one client device is configured to execute a first software application for implementing a method according to the first aspect.

In a third aspect, an embodiment of the present disclosure provides a computer program product for remotely monitoring a plurality of sub-systems, the computer program product comprising a non-transitory machine-readable data storage medium having stored thereon program instructions that, when accessed by a processing device, cause the processing device to implement a method according to the first aspect.

The present disclosure provides the aforementioned method, the aforementioned system, and the aforementioned computer program product for remotely monitoring a plurality of sub-systems. Herein, the method enables polling the data from the given sub-system at the given polling frequency (that can be adjusted as required), and then transmitting data and/or data points (for backing up) to the centralized server at the given upload frequency, in real time or near-real time (without any delay/latency). Beneficially, this facilitates in providing an immediate insight of operations of the sub-systems that are geographically dispersed, and to accordingly react when there are issues with the sub-systems. Resultantly, there is a real-time visibility (i.e., transparency) of performances and statuses of the sub-systems and thus, there is a minimal downtime for rectifying the issues. In this manner, the method supports rapid corrective action by sending an appropriate resource for said issues. Furthermore, the system and the method enables accurate and reliable remote monitoring of any digital assets (namely, data sources). The system and method also incorporate principles and technologies including real-time device interfacing, big data management, internet of things (IoT) device management and control, just-in-time unique device security certification, process and workflow automation, abstracted visualisation, machine learning, among others. The system and method are fast, effective, and can be implemented with ease.

The method facilitates in remote monitoring activities of the plurality of sub-systems using the at least one client device. Such monitoring comprises observing and checking information generated by the plurality of sub-systems, services delivered by the plurality of sub-systems, services used by the plurality of sub-systems, and services leveraged by the plurality of sub-systems, and the like. It will be appreciated that when physical access to locations of the plurality of sub-systems is restricted, remotely monitoring the plurality of sub-systems helps targeting exactly which sub-system is working or how it is performing and what type of issues/problems it is facing. However, a user of the at least one client device may disable remote monitoring for any sub-system, as and when required.

Throughout the present disclosure, the term “sub-system” refers to any device or any software program whose remote monitoring is required to be performed. The computing device could be a laptop, a computer, a smartphone, a tablet, and the like. The server could be a cloud server, a physical server, or similar. The operating system could be Microsoft Windows operating system, Google's Android operating system, Linux operating system, and the like. The second software application can be any software application program that executes on at least one of: the computing device, the server, the operating system. In an example, a given sub-system may be a video conferencing codec, a server, a digital media player, a networking device, a display device, or similar. It will be appreciated that some or an entirety of plurality of sub-systems may be geographically dispersed from each other.

Throughout the present disclosure, the term “first software application” refers to a program (comprising a set of instructions which are executable to perform steps of the aforementioned method) for remotely monitoring the plurality of sub-systems. Notably, the first software application enables the at least one client device in consolidating the data (namely, payload information) from the plurality of sub-systems, and transmitting it to the centralized server, for storage thereat. It will be appreciated that the first software application may support industry-standard protocols and customized application program interface (API) integrations, for efficient, adaptable, and flexible remote monitoring for each of the plurality of sub-systems. The first software application may provide local monitoring of its own host (namely, the at least one client device).

Throughout the present disclosure, the term “client device” refers to a device that is capable of executing the first software application, and is capable of connecting with the plurality of sub-systems. Optionally, the at least one client device comprises a processor that is configured to execute the first software application. A given client device may be a laptop, a computer, a smartphone, a tablet, and the like. The given client device is communicably coupled to a given sub-system, wirelessly and/or in a wired manner, via a communication network. It will be appreciated that the communication network may be wired, wireless, or a combination thereof. Examples of the communication network may include, but are not limited to, Internet, a local network (such as, a TCP/IP-based network, an Ethernet-based local area network, an Ethernet-based personal area network, a Wi-Fi network, and the like), Wide Area Networks (WANs), Metropolitan Area Networks (MANs), a telecommunication network, and a radio network. In an exemplary implementation, the at least one client device may be communicably coupled to the plurality of sub-systems using an ad hoc network.

Throughout the present disclosure, the term “polling” refers to (actively) obtaining the data from the plurality of sub-systems. It will be appreciated that the polling not only monitors a status of the given sub-system but may also monitor statuses of various components (such as fans, power supplies, and the like) associated with the given sub-system. Beneficially, this enables in remotely monitoring a failure of the given sub-system, based on the statuses of various components associated with the given sub-system. The polling may be performed by employing at least one of: Internet Control Message Protocol (ICMP), Simple Network Management Protocol (SNMP). In addition the polling can be done using for example serial connections via USB (universal serial bus) or similar if needed. It will be appreciated that prior to polling data from the given sub-system, the at least one client device checks a state of the given sub-system. In this regard, a data request may be sent from the at least one client device to the given sub-system, and when the given sub-system is ready for polling, the given sub-system echoes the data request back to the at least one client device. Moreover, when the given sub-system does not echo the data request back to the at least one client device, the at least one client device considers the given sub-system to be down (i.e., not ready for polling).

Furthermore, the term “polling frequency” refers to how frequently the at least one client device polls (namely, obtains) the data from the given sub-system. As an example, the at least one client device polls the data from the given sub-system, for example, after every 60 seconds, after every 6 hours, or similar. Optionally, the given polling frequency lies in a range of 1 second to 86400 seconds (e.g, 24 hours). As an example, the given polling frequency may be from 100, 500, 1000, 2000, 4000, 9000, 15000, 25000, 40000 or 65000 seconds up to 30000, 40000, 50000, 60000, 70000 or 86400 seconds. It will be appreciated that data from different sub-systems may be polled at different polling frequencies. The given polling frequency is optionally adjustable. The given polling frequency may vary according to a desired speed of a response by a user, an overhead (such as a bandwidth) of polling, and the like. Technical effect of changing the polling frequency between a client and the target system allows the user change the granularity in terms of time. The shorter the polling frequency the faster data changes can be escalated. In addition the short the frequency the more likely the system will be able to identify an intermittent fault. On the other hand if a sub-system has been found to be robust or not so time critical from its uptime point of view the polling frequency can be change to less frequent. In theory polling frequency can be longer than 24 hours but in order to provide way to identify (and act on) faults in a reasonable time typically polling frequency is below that.

Control for the polling frequency adjustment could be based on any event or input data received. E.g. If the target device makes a call (in call=Yes) then increase the polling frequency, If Error Message received from device, increase polling frequency, for example

Optionally, the method further comprises:
installing at least one plugin on the least one client device, prior to polling the data from the plurality of sub-systems;
determining whether the data to be polled has a structured form or an unstructured form;
when it is determined that the data to be polled has the structured form, directly polling the data from the plurality of sub-systems via the at least one plugin; and
when it is determined that the data to be polled has the unstructured form, transforming the unstructured form of the data into the structured form using the at least one plugin, prior to polling the data from the plurality of sub-systems.

Herein, the term “plugin” refers to a software that acts as an add-on functionality to the least one client device. Plugins are well-known in the art. It will be appreciated that the data from the given sub-system is polled by the at least one client device, via the at least one plugin. A given plugin may be installed on the at least one client device via script mechanisms. In addition the given plugin may be installed on the at least one client device manually or using automated mechanisms from central systems. The at least one plugin may enable its customization upon receiving a customization request from the at least one client device.

Furthermore, prior to polling, the at least one plugin determines whether the data to be polled has the structured form or the unstructured form. The structured form has the data to be polled in a pre-defined and highly organized form. As an example, the structured form of data may comprise names, dates, addresses, credit card numbers, stock information, geolocation, and the like. The structured form of data may be represented using any type of data structure. The unstructured form has the data to be polled in a random and unorganized form. As an example, the unstructured form of data may comprise text files, video files, audio files, mobile activities, social media posts, satellite imageries, surveillance imageries, and the like. It will be appreciated that when the data to be polled has the structured form, it is directly polled from the given sub-system via the at least one plugin. When the data to be polled has the unstructured form, it is transformed into the structured form by the at least one plugin, prior to polling. This is because transmission of the structured form of data from the given sub-system to the at least one client device is faster, as compared to the unstructured form of data. Furthermore subsequent processing of the structured form data is faster and requires less computing resources, as compared to the unstructed form of data.

The at least one plugin may be designed based on a type of a sub-system. The at least one plugin may obtain the data to be polled in the structured form via an API call. In this regard, the at least one plugin execute the API call on the at least one client device for polling the data. The at least one client device receives the structured form of data and surrounds it with a standardised acquisition data such as information pertaining to a sub-system from which it is received, a time of capture, time received, a unique identifier, and the like. Optionally, the unique identifier is a string of at least one: alphabets, numerals, special characters, symbols. Additionally or alternatively to using API calls alternative forms of plugin connection to the target device such as serial, USB might be used.

Once the data is obtained by the at least one client device, the data is classified into the given category. Optionally, the plurality of categories comprises at least two of: telemetry, events, alarms, audits, usage, files. The aforesaid classification enables in easy and faster processing and transmission of the (categorised) data. In an example, when the data is categorised as telemetry data, it is processed according to a telemetry data processing pipeline. The term “telemetry” refers to in-situ collection of measurements (of certain parameters) at the given sub-system, and automatic transmission of such measurements to the at least one client device. For example, data from a weather satellite may be referred to as telemetry data. The telemetry data may be stored for subsequent analysis to identify anomalies. The term “event” refers to an occurrence of an activity at the given sub-system. Data or a set of records sequenced chronologically according to a given event is referred to as event data. The term “alarm” refers to an alert of a notable event in form of a notification. The notification may be a graphical notification, a text notification, an audio notification, and the like. The term “audits” refers to a formal, systematic evaluation in terms of quality and utility of the data received from the given sub-system. The term “usage” refers to data collected when the given sub-system is being used. As an example, the given sub-system may be used for browsing the Internet, downloading and executing applications, checking emails, posting on social media platforms, playing games, watching videos, and the like. The term “file” refers to a resource for storing at least one of: data, information, settings, commands in a storage medium. The file may be a text file, an audio file, a video file, and the like. It will be appreciated that the plurality of categories may comprise other categories in addition to the aforementioned categories. Optionally, when classifying the data into the given category, the at least one client device is configured to employ at least one data classification algorithm. As an example of classification algorithm is clustering based on type of data. For example temperature can be assigned by classification to Telemetry category and Serial number to Audit category.

Throughout the present disclosure, the term “centralized server” refers to hardware, software, firmware, or a combination of these for at least backing up and storing data and/or data points received from the at least one client device in real time or near real time. In such a case, the centralized server always has an up-to-date version of the data. Optionally, the centralized server comprises a data repository for storing the data and/or data points in an organized (namely, structured) manner, thereby, allowing for easy access (namely, retrieval) and updation/processing of said data. Optionally, the centralized server is communicably coupled to the at least one client device via the communication network.

When the at least one client device is polling data from the given sub-system for a first time, the polled data is directly transmitted (i.e., without any analysis) to the centralized server (after said polled data is requisitely classified). This is because during the first time, there may not be any pre-stored data present at the centralized server. Further, when the at least one client device is subsequently polling the given sub-system (for example, such as for a second time), the classified data is compared with the (corresponding) pre-stored data at the centralized server, to determine the plurality of data points of the classified data that has changed (for example, between the first time and the second time). In this regard, a given data point of the classified data would comprise an up-to-date information in the classified data, and thus only such data points need to be replaced (namely, backed up) in the classified data, in order to maintain an up-to-date data at the centralized server. It will be appreciated that the classified data may be analyzed based on a set of rules defined according to user(s) of the given sub-system. After said analysis, reports may be generated to ascertain trends based on a usage of the given sub-system.

The term “upload frequency” refers to how frequently the at least one client device transmits (namely, uploads or backs up) the changed data points of the classified data to the centralized server. As an example, the at least one client device transmits the changed data points to the centralized server, for example, after every 30 minutes, after every 4 hours, or similar. Optionally, the given upload frequency lies in a range of 1 second to 86400 seconds. As an example, the given upload frequency may be from 100, 500, 1000, 2000, 4000, 9000, 15000, 25000, 40000 or 65000 seconds up to 30000, 40000, 50000, 60000, 70000 or 86400 seconds. It will be appreciated that, upon receiving the data and/or data points, the centralized server may utilize said data and/or data points for at least one of: post event processing, summarising (to enable rapid access of said data), anomaly detection (by reviewing said data with pre-configured anomalies). Furthermore the upload frequency can be set to exceed 24 hours but in order to have reasonable response time of the system it is preferred to keep below said limit.

Since a number of times the data points to be uploaded to the centralized server could not exceed a number of times the data is to be polled from the given sub-system, the given upload frequency should remain equal to or less than the given polling frequency. Optionally, in this regard, the given polling frequency is greater than the given upload frequency. In an example, the at least one client device polls the data after every 30 minutes but transmits the changed data points after every 4 hours. Alternatively, optionally, the given polling frequency is same as the given upload frequency. In an example, the at least one client device polls the data after every 30 seconds and transmits the changed data points after every 30 seconds.

Optionally, the method further comprises adjusting the given upload frequency based on at least one of: a number of changed data points, a change in a status of an alarm, a usage threshold. Herein, greater the number of changed data points, greater is the given upload frequency, and vice versa. This is because when a number of changed data points is high, data at the centralized server is required to be updated in a frequent manner. Furthermore, the change in the status of the alarm (i.e., an open status or a closed status of the alarm) is used to adjust the upload frequency when the data is categorised in the alarm category. Greater the changes in the status of the alarm, greater is the given upload frequency, and vice versa. This is because when the status of the alarm changes frequently, corresponding changes needs to reflected at the centralized server, and thus the given upload frequency is required to be high. Moreover, the usage threshold is used to adjust the upload frequency when the data is categorised in the usage category. Greater the usage threshold, greater is the given upload frequency, and vice versa.

Optionally, the method further comprises installing a caching software on the at least one client device, wherein the caching software stores the data in a cache memory associated with the at least one client device. The technical benefit of such caching software is that it ensures that no loss of data occurs in an event wherein a connectivity between the at least one client device and the centralized server is lost (during intermittent network environments). Thus, the first software application is designed to work with synchronous and asynchronous network environments.

Optionally, the method further comprises receiving at least one command from the centralized server, and executing the at least one command at a given sub-system. The at least one client device is centrally configured to receive and execute the at least one command at the given sub-system. The at least one command may comprise ad hoc requests from local (the at least one client device) command line to execute a task at the given sub-system. Such a task may pertain to, for example, rebooting a device such as a digital signage media player, video conferencing codec, or similar. Furthermore the commands can be parsed to find context to assess the results output from the executed commands. Normalization and adjustment or normalization of the results from the command can be carried out.

Optionally, the at least one client device is configured to:
receive a given alarm setting from the centralized server; and
open or close a given alarm according to the given alarm setting irrespective of a connectivity between the at least one client device and the centralized server.

In this regard, once the alarm setting is received by the at least one client device, the given alarm is opened (namely, raised) or closed by the at least one client device whether the connectivity between the centralized server and the at least one client device is maintained or not. The alarm is opened when the given alarm setting comprises an open condition for the alarm, and similarly the alarm is closed when the given alarm setting comprises a closed condition for the alarm. It will be appreciated that the given alarm setting is received by the at least one client device in real time or near-real time. Optionally, the at least one client device is configured to transmit data pertaining to a given alarm only when the at least one client device is well-connected with the centralized server.

Optionally, the method further comprises providing an interactive user interface on a device associated with an estate administrator of the plurality of sub-systems, for enabling the estate administrator to at least view data stored at the centralized server. The interactive user interface is a graphical user interface. The device associated with the estate administrator could be a laptop, a computer, a smartphone, a tablet, and the like. The interactive user interface may be accessible via a web browser. Logins via the interactive user interface can be performed by using valid credentials. Upon logging, the estate administrator can at least view the data stored at the centralized server using the interactive user interface. The interactive user interface may have a menu comprising options such as shown home screen. A same option may also be triggered by selecting a logo present on the interactive user interface.

The interactive user interface may allow the estate administrator to at least view their own estates through various perspectives, for example, geographical and logical structures such as location, usage (number of calls and minutes), status of the plurality of sub-systems and their services, incidents within a given sub-system, states of components within the given sub-system, and the like. The estate administrator could also perform at least one operation (such as modification, analysis, deletion) on the data. Such a data comprises the pre-stored data at the centralized server and the plurality of data points (i.e., new data) transmitted to the centralized server. Moreover, the estate administrator may use filters such as company filters, location filters, for selectively viewing data for different types of sub-systems or locations (such as a site, a location, a setup, a room, a company, and a device). The interactive user interface may also have a provision for storing pre-defined filters for a rapid recall. Optionally, the interactive user interface comprises a service management dashboard for viewing incidents and service requests. Most content within the interactive user interface is displayed in forms of dashboard widgets as well as list data. This allows the estate administrator to view key performance and statistics information as well as critical operational data pertaining to each item in the list data. All information presented using the interactive user interface is based on a same logical structure for ensuring a simple, intuitive, and responsive user experience.

Optionally, the centralized server is configured to:
process data of a given category for obtaining information pertaining to at least a sub-system wherefrom said data is polled, a metric represented by said data, a value or a status of the metric, and a pipeline of said data;
create a plurality of streams, wherein a given stream is created by combining the information pertaining to the sub-system wherefrom said data is polled, the metric represented by said data, and the pipeline of said data, the given stream having a normalised data type;
generate a logic layer by applying a data model to the plurality of streams;
create a plurality of virtual streams using the logic layer, wherein a number of the plurality of virtual streams is less than a number of the plurality of streams; and
process the logic layer and the plurality of virtual streams to detect an anomaly in said data.

It will be appreciated that the aforementioned steps are performed when the data and/or data points are transmitted to the centralized server. Since the at least one client device accurately knows the sub-system wherefrom said data is polled, the at least one client device sends this information to the centralized server along with the data and/or data points transmitted to the centralized server. When processing the data of the given category, the data may be broken down to obtain the metric (for example, such as a status, a temperature, a type of connection, and the like) represented by said data. Thereafter, a value or a status of the metric (for example, an “on” status, a temperature of 37.8 degree Celsius, an “open” connection, and the like) is derived by the centralized server. The pipeline of said data is a path (namely, journey) of said data from the given sub-system (namely, a target) to the centralized server. Such a pipeline is accurately known to the centralized server when the centralized server receives said data.

Each unique combination of the information pertaining to the sub-system wherefrom said data is polled, the metric represented by said data, and the pipeline of said data creates a unique stream. Each of the plurality of streams has the normalised data type (such as integers, floats, strings, blob, and the like) is represented in a required manner (for example, a change of value from 1.2 to 1, a change from 1 to “off”, a change from 0 to “on”). Each stream could have multiple adjustments.

Furthermore, the logic layer is generated when the data model (for example, such as an Entity-attribute-value (EAV) data model) is applied to the plurality of streams. Such a data model could be a standard model used to create descriptive hierarchical models without define contents. The data model may utilize an infinite structured hierarchy to support structuring of the data contained in plurality of streams. The data model could be modified to change from a hierarchy to a mesh network, thus allowing for introduction of data perspectives. As an example, when the EAV data model is used, a single entity in a given stream in a hierarchy can be related to one or more other hierarchies without duplicating an original entity. Such a modification allows a complete mesh to be created without needing information on actual entities. It will be appreciated that the EAV data model facilitates creation of structural representation of entity-related attributes and values (key value pairs). As entities-related attributes are created, the logic layer examines such attributes and searches data of the given stream. When matches are found, the logic layer generates a match probability value pertaining to a connection between a virtual stream and a given entity, thus allowing for a relationship to be identified between the virtual stream and the given entity. A calculation for the probability value can be driven by any form or logic from simple to continual learning machine learning (ML).

Optionally, the logic layer consolidates at least two streams from amongst the plurality of streams to create a given virtual stream from amongst the plurality of virtual streams. Moreover, each of the virtual stream retains metadata related to both the plurality of (source) streams as well as a logic applied to create a new virtual stream. Each of the plurality of streams retains its normalised data type to ensure data integrity. As stream(s) have individual metric(s), a corresponding virtual stream retains a same attributes even though these attributes are compounded (namely, consolidated) in the corresponding virtual stream. The plurality of virtual streams can be further consolidated into additional virtual streams for further consolidation and or decision making if required. Each of the plurality of streams is a locator for time series data and not a continual data stream. This means that each stream could be used to locate any data pertaining to a particular stream regardless of date/time associated with the stream. As each of the plurality of streams represents a normalised dataset and is detached form actual time series values, the data in such stream is prepared for ML experiment/modelling.

It will be appreciated that the logic layer has 1−n input streams. Thus, the logic layer processes 1−n values per stream and re-processes based on at least one of: a value per stream, a time change for a given (input) stream, a state change in the given (input) stream and its value. The aforesaid processing is based on string, numerical, statistical, and logical operands. The output from the logic layer is virtual streams. Since the stream can related to any of the plurality of categories (such as telemetry, events, alarms, and the like), the virtual stream can be of any format as that of the stream. The logic layer could also be configured to raise events, into a given virtual stream, based on a pre-defined condition. As an example, the pre-defined condition may be to raise an event that a door sensor is open or closed, when a temperature of a component of a given sub-system is greater than 50 degrees Celsius. The pre-defined conditions can be compounded based on a single stream or multiple streams. Examples may include, exceeding minimum/maximum over time, no data within an expected time, a standard deviation excessive variance.

It will also be appreciated that the centralized server processes the logic layer based on at least one pre-defined ML model. Such a model may be applied to stream(s) and create virtual stream(s). The logic layer can process values from multiple streams over time, and the at least one pre-defined ML model can be implemented to the anomaly in said data. Anomaly detection is the identification of the plurality of data points that do not conform to an expected pattern or value. Compounding of the logic layer as well as outputting to virtual streams may be used for simple anomaly detection.

The present disclosure also relates to the system as described above. Various embodiments and variants disclosed above apply mutatis mutandis to the system.

Optionally, the system further comprises a centralized server communicably coupled to the at least one client device, wherein the centralized server is configured to store data and/or data points transmitted to it by the at least one client device. The centralized server has been described above in detail in the description.

The present disclosure also relates to the computer program product as described above. Various embodiments and variants disclosed above apply mutatis mutandis to the computer program product.

Throughout the present disclosure, the term “computer program product” refers to a software product comprising program instructions that are recorded on the non-transitory machine-readable data storage medium, wherein the software product is executable upon a computing hardware (i.e., the processing device) for implementing the aforementioned steps of the method for remotely monitoring a plurality of sub-systems.

The program instructions stored on the non-transitory machine-readable data storage medium can direct the processing device to function in a particular manner, such that the processing device executes processing steps for remotely monitoring a plurality of sub-systems. Examples of the non-transitory machine-readable data storage medium includes, but are not limited to, an electronic storage device, a magnetic storage device, an optical storage device, an electromagnetic storage device, a semiconductor storage device, a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, or any suitable combination thereof.

Throughout the present disclosure, the term “processing device” refers to a device that is capable of processing the program instructions of the computer program product. Optionally, the processing device is implemented as a part of the at least one client device. The processing device may, for example, be a microprocessor, a microcontroller, a processing unit, or similar.

### DETAILED DESCRIPTION OF THE DRAWINGS

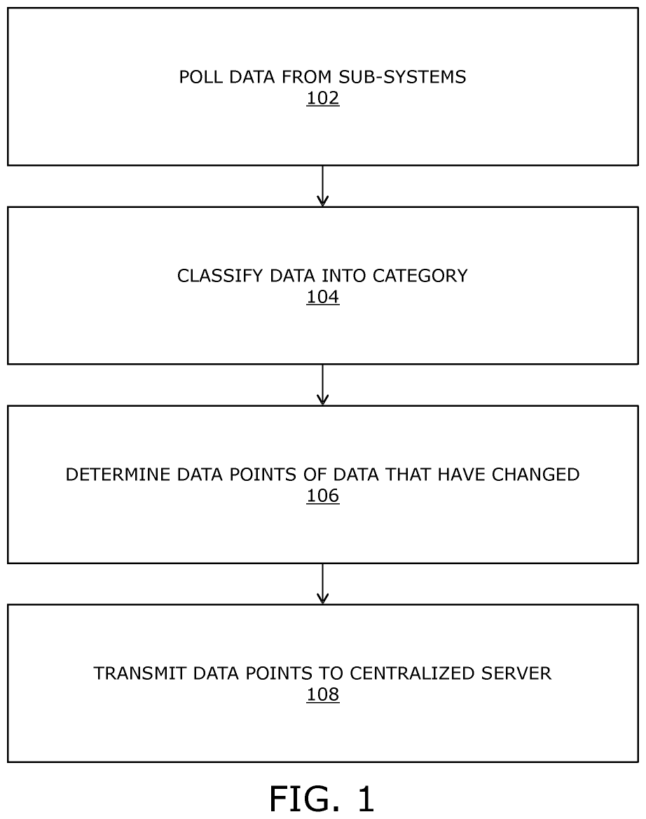

Referring to FIG. 1, illustrated is a flowchart depicting steps of a method for remotely monitoring a plurality of sub-systems, in accordance with an embodiment of the present disclosure. At step 102, data from a plurality of sub-systems is polled, wherein a given sub-system comprises at least one of: a computing device, a server, an operating system, a second software application, and wherein data from the given sub-system is polled at a given polling frequency. At step 104, the data is classified into a given category from amongst a plurality of categories. At step 106, the classified data is analyzed, based on pre-stored data at a centralized server, to determine a plurality of data points of the classified data that have changed. At step 108, the plurality of data points are transmitted to the centralized server at a given upload frequency, for storage thereat.

The aforementioned steps are only illustrative and other alternatives can also be provided where one or more steps are added, one or more steps are removed, or one or more steps are provided in a different sequence without departing from the scope of the claims herein.

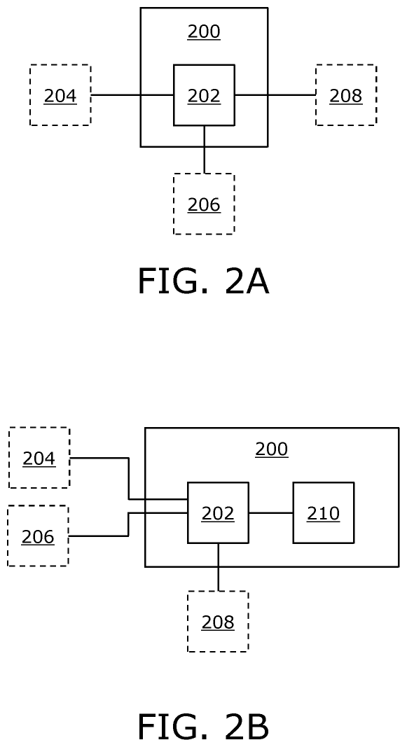

Referring to FIGS. 2A and 2B, illustrated are block diagrams of a system 200 for remotely monitoring a plurality of sub-systems, in accordance with an embodiment of the present disclosure. The system 200 comprises at least one client device (depicted as a client device 202) that is communicably coupled to the plurality of sub-systems (depicted as sub-systems 204, 206, 208). The client device 202 is configured to poll data from a given sub-system at a given polling frequency. In FIG. 2B, the system 200 further comprises a centralized server 210 communicably coupled to the client device 202. The client device 202 is configured to transmit the data and/or data points to the centralized server 210 at a given upload frequency.

It may be understood by a person skilled in the art that the FIGS. 2A and 2B include simplified architectures of the system 200 for sake of clarity, which should not unduly limit the scope of the claims herein. The person skilled in the art will recognize many variations, alternatives, and modifications of embodiments of the present disclosure.

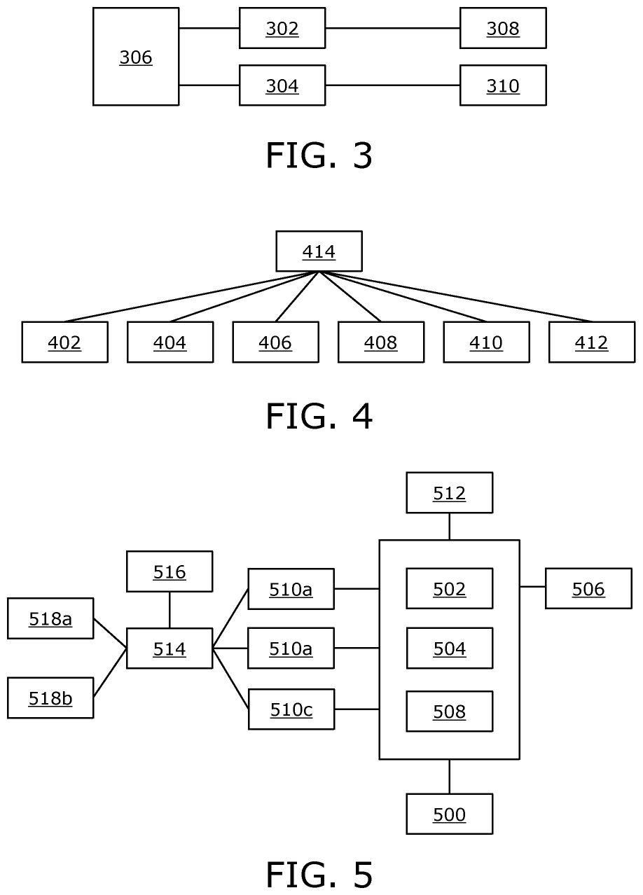

Referring to FIG. 3, illustrated is an exemplary scenario of using plugins 302 and 304, in accordance with an embodiment of the present disclosure. Herein, the plugins 302 and 304 are installed on a client device 306, prior to polling data from sub-systems 308 and 310, respectively. A given plugin is configured to determine whether data to be polled from a given sub-system has a structured form or an unstructured form. Let us consider that the data to be polled from the sub-system 308 has the structured form, whereas the data to be polled from the sub-system 310 has the unstructured form. In such a case, the data from the sub-system 308 is directly polled via the plugin 302. The plugin 302 receives the (structured) data from the sub-system 308 using an application programming interface (API) call. Moreover, the unstructured form of the data from the sub-system 310 is transformed into the structured form using the plugin 304, prior to polling the data from the sub-system 310. The plugin 304 receives the (unstructured) data from the sub-system 310 using a non-API call.

Referring to FIG. 4, illustrated are various types of categories of classifying data, in accordance with an embodiment of the present disclosure. The data is classified into a given category from amongst various types of categories namely, telemetry 402, events 404, alarms 406, audits 408, usage 410, files 412. Such a classification is performed by a client device 414 upon polling data from a sub-system (not shown).

Referring to FIG. 5, illustrated is a process flow executed by a centralized server (not shown), in accordance with an embodiment of the present disclosure. Firstly, data of a given category 500 is processed for obtaining information pertaining to at least a sub-system 502 wherefrom said data is polled, a metric 504 represented by said data, a value or a status 506 of the metric 504, and a pipeline 508 of said data. Next, a plurality of streams (depicted as streams 510a, 510b, and 510c) are created, wherein a given stream is created by combining the information pertaining to the sub-system 502, the metric 504 represented by said data, and the pipeline 508 of said data. The given stream has a normalised data type 512. Further, a logic layer 514 is generated by applying a data model (for example, such as an entity-attribute-value (EAV) data model 516) to the streams 510a-510c. Next, a plurality of virtual streams (depicted as virtual streams 518a and 518b) are created using the logic layer 514. Furthermore, the logic layer 514 and the virtual streams 518a and 518b are processed to detect an anomaly in said data.

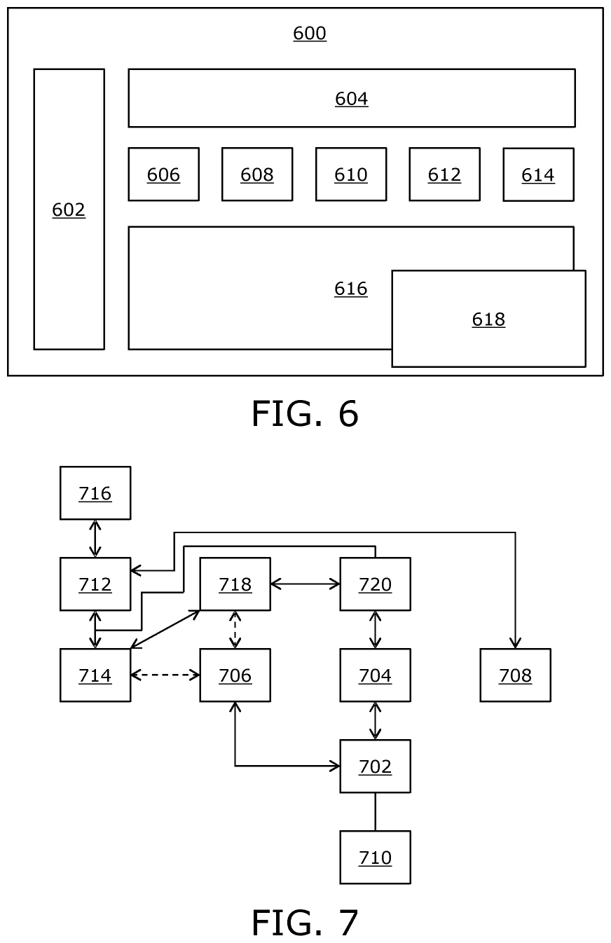

Referring to FIG. 6, illustrated is an exemplary interactive user interface 600 on a device (not shown) associated with an estate administrator (not shown), in accordance with an embodiment of the present disclosure. As shown, the interactive user interface 600 comprises a menu 602, an estate management view 604, a number of sub-systems 606, a number of setups 608, a health indicator 610 of an sub-system, a window 612 of open incidents, a current status 614 of a given setup, a geographical view 616 of locations of sub-systems, and a sub-system/location filter 618. The menu 602 may have options for example, such as home, service management, administration, and the like.

Referring to FIG. 7, illustrated is an exemplary use case of a system (not shown) for remotely monitoring a plurality of sub-systems, in accordance with an embodiment of the present disclosure. As shown, a client device 702 is communicably coupled with an internet of things (IoT) device twin 704, an IoT hub 706, and an application programming interface (API) plugin configuration module 708. A plugin 710 is installed on the client device 702. A database 712 is communicably coupled with the API plugin configuration module 708 and a schedule configuration module 714, and an interactive user interface 716 of a device (not shown) associated with an estate administrator (not shown). The schedule configuration module 714 performs a configuration operation at 718 for the IoT hub 706, and at 720 for the IoT device twin 704. The schedule configuration module 714 is also coupled with the IoT hub 706.

It may be understood by a person skilled in the art that the FIGS. 3, 4, 5, 6, and 7 are merely examples, which should not unduly limit the scope of the claims herein. The person skilled in the art will recognize many variations, alternatives, and modifications of embodiments of the present disclosure. For example, referring to FIG. 6, the interactive user interface 600 may also comprise key performance and statistics information, critical operational data pertaining to a sub-system, dashboard widgets, video collaboration and digital signage structures and information, and the like.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for remotely monitoring a plurality of sub-systems, the method being implemented by a first software application executing on at least one client device that is communicably coupled to the plurality of sub-systems, the method comprising:
polling the data from the plurality of sub-systems, wherein a given sub-system comprises at least one of: a computing device, a server, an operating system, a second software application, and wherein data from the given sub-system is polled at a given polling frequency;
classifying the data into a given category from amongst a plurality of categories;
analyzing the classified data, based on pre-stored data at a centralized server, to determine a plurality of data points of the classified data that have changed; and
transmitting the plurality of data points to the centralized server at a given upload frequency, for storage thereat.

2. A method according to claim 1, further comprising:
installing at least one plugin on the least one client device, prior to polling the data from the plurality of sub-systems;
determining whether the data to be polled has a structured form or an unstructured form;
when it is determined that the data to be polled has the structured form, directly polling the data from the plurality of sub-systems via the at least one plugin; and
when it is determined that the data to be polled has the unstructured form, transforming the unstructured form of the data into the structured form using the at least one plugin, prior to polling the data from the plurality of sub-systems.

3. A method according to claim 1, further comprising adjusting the given upload frequency based on at least one of: a number of changed data points, a change in a status of an alarm, a usage threshold.

4. A method according to claim 1, further comprising installing a caching software on the at least one client device, wherein the caching software stores the data in a cache memory associated with the at least one client device.

5. A method according to claim 1, further comprising receiving at least one command from the centralized server, and executing the at least one command at a given sub-system.

6. A method according to claim 1, wherein the plurality of categories comprise at least two of: telemetry, events, alarms, audits, usage, files.

7. A method according to claim 1, wherein the given polling frequency is greater than the given upload frequency.

8. A method according to claim 1, wherein the given polling frequency lies in a range of 1 second to 86400 seconds.

9. A method according to claim 1, wherein the given upload frequency lies in a range of 1 second to 86400 seconds.

10. A method according to claim 1, further comprising providing an interactive user interface on a device associated with an estate administrator of the plurality of sub-systems, for enabling the estate administrator to at least view data stored at the centralized server.

11. A method according to claim 1, wherein the centralized server is configured to:
process data of a given category for obtaining information pertaining to at least a sub-system wherefrom said data is polled, a metric represented by said data, a value or a status of the metric, and a pipeline of said data;
create a plurality of streams, wherein a given stream is created by combining the information pertaining to the sub-system wherefrom said data is polled, the metric represented by said data, and the pipeline of said data, the given stream having a normalised data type;
generate a logic layer by applying a data model to the plurality of streams;
create a plurality of virtual streams using the logic layer, wherein a number of the plurality of virtual streams is less than a number of the plurality of streams; and
process the logic layer and the plurality of virtual streams to detect an anomaly in said data.

12. A system for remotely monitoring a plurality of sub-systems, the system comprising at least one client device communicably coupled to the plurality of sub-systems, wherein the at least one client device is configured to execute a first software application for implementing a method according to claim 1.

13. A system according to claim 12, further comprising a centralized server communicably coupled to the at least one client device, wherein the centralized server is configured to store data and/or data points transmitted to it by the at least one client device.

14. A computer program product for remotely monitoring a plurality of sub-systems, the computer program product comprising a non-transitory machine-readable data storage medium having stored thereon program instructions that, when accessed by a processing device, cause the processing device to implement a method according to claim 1.
